(19) United States
(12) Patent Application Publication
(10) Pub. No.: US 2025/0318541 A1
(43) Pub. Date: Oct. 16, 2025

(54) Banana Holder with Enhanced Airflow and Ethylene Gas Management System

(71) Applicant: Sean Peterson, Cypress, TX (US)

(72) Inventor: Sean Peterson, Cypress, TX (US)

(21) Appl. No.: 18/635,787

(22) Filed: Apr. 15, 2024

(51) Int. Cl. A23B 7/152; A47F 7/00

(52) U.S. Cl. CPC A23B 7/152; A47F 7/0071

(57) ABSTRACT

“The invention introduces a banana holder designed to enhance freshness and extend the shelf life of bananas through an innovative airflow and ethylene gas management system. The holder features a base and an upper support connected by a hollow perforated pole optimized for air circulation, optionally fitted with replaceable ethylene absorbers or filters. A new variant incorporates this holder into an under-cabinet design with a fold-up feature, using the same securement zones without a traditional pole or base. This system minimizes contact between bananas, improving air circulation, reducing bruising, and preventing disease spread. The adaptable design caters to diverse environments and capacities, enhancing user convenience and fruit longevity.”

### BACKGROUND OF THE INVENTION

Traditional methods of storing bananas, such as hanging the fruits in a bunch, placing them in a bowl, or laying them directly on a counter, each pose significant drawbacks. Hanging bananas saves counter space but clusters the bananas closely together, which restricts airflow and promotes the accumulation of ethylene gas, often leading to uneven ripening. Placing bananas in a bowl can cause bruising due to pressure points and further restricts air circulation, while laying bananas on a counter exposes them to physical damage and increased ethylene production from nearby fruits, accelerating their degradation. These common storage methods fail to address the critical need for managing ethylene gas and do not provide adequate ventilation, which is crucial for maintaining fruit freshness and prolonging shelf life.

The proposed design of the new banana holder marks a significant improvement over these traditional methods by introducing an innovative airflow system specifically engineered to facilitate the effective dispersion of ethylene gas and simultaneously draw in cooler, fresher air. This system enhances the ripening process, making it more uniform and controlled. The holder features a uniquely structured design where each banana is individually supported, allowing for optimal spacing between fruits. This lessens the exposure of ethylene emitted by one banana from accelerating the ripening of its neighbors compared to being maintained together as a bunch, thereby improving fruit freshness.

One key to this design is the integration of a vertically extending hollow pole with strategically placed perforations. These are not merely passive openings but are designed to induce the upward and outward flow of ethylene gas at the top while drawing in cooler air from below. This dynamic air exchange creates a consistently refreshed micro-environment that is vital for slowing down the natural ripening process and enhancing the overall usability of the bananas. Importantly, this airflow system operates entirely passively, leveraging natural air movements without the need for electronic or mechanical assistance, making it both eco-friendly and low-maintenance.

Through these innovations, the new banana holder addresses the shortcomings of existing models and sets a new standard for how fruit can be more effectively stored and managed in both home and commercial environments. This focus on improved air circulation and ethylene management presents a practical solution to a long-standing problem in fruit preservation.

### BRIEF DESCRIPTION OF DRAWINGS

The following description of the invention will be more fully understood with reference to the accompanying drawings, in which:

FIG. 1 is a top perspective view of a first embodiment of a holder according to the present invention with a plurality of bananas hanging therefrom.

FIG. 2 is a top perspective view of the holder without any bananas hanging therefrom.

FIG. 3 is a top perspective view of a base of the holder.

FIG. 4 is a bottom perspective view of the base of the holder.

FIG. 5 is a perspective view of a pole of the holder.

FIG. 6 is a top perspective view of an upper support of the holder.

FIG. 7 is a bottom perspective view of the upper support of the holder.

FIG. 8 is a top perspective view of a holder according to a second embodiment of the present invention shown with a plurality of individual bananas hanging therefrom.

FIG. 9 is a top perspective view of the holder of the second embodiment without any bananas hanging therefrom.

FIG. 10 is a top perspective view of an upper support of the holder of the second embodiment of the present invention.

FIG. 11 is a bottom perspective view of the upper support of the holder of the second embodiment of the present invention.

FIG. 12 is a perspective view of a female fastener for the upper support.

### DESCRIPTION OF THE INVENTION

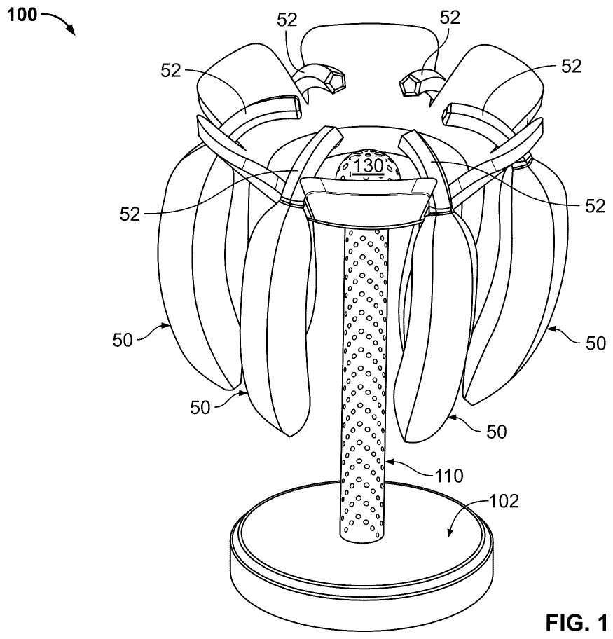

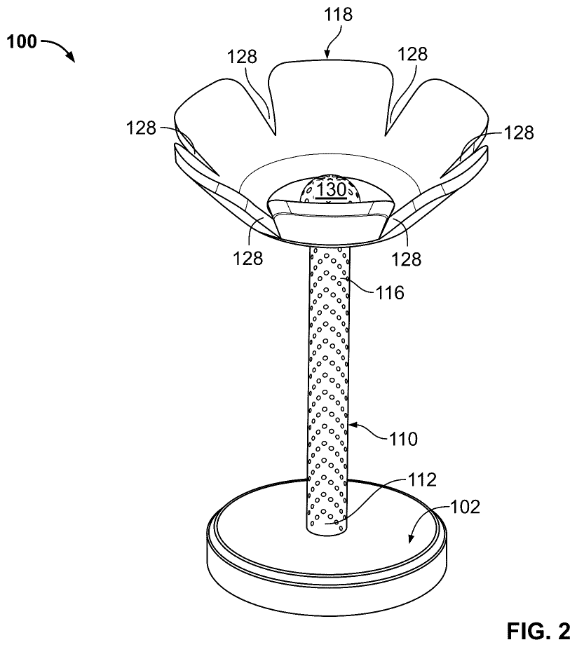

1. Referring to FIGS. 1 and 2, the present invention is directed to a holder 100 that allows a plurality of individual bananas 50 to hang downward from their stem 52. Hanging of individual bananas 50 allows ripening of each banana that constitutes a significant improvement over conventional banana holding devices. Holder 100 comprises a base 102, a pole 12, an upper support 118, and a hollow fastener 130. Pole 110 extends upward from base 102 and comprises lower and upper end portions 112 and 116. Upper support 118 is engaged with upper end portion 116 of pole 110 by hollow and perforated fastener 130. Upper support 118 comprises a plurality of securement zones 128. Each of securement zones 118 is adapted to allow stem 52 of an individual banana 50 to be secured and allow individual banana 50 to hang downward therefrom.

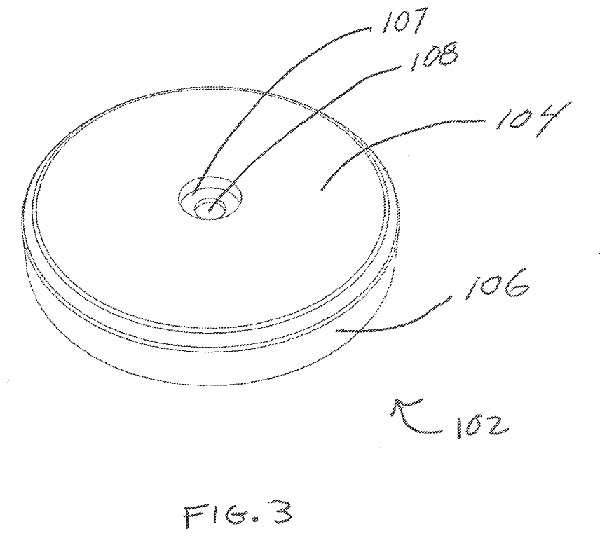

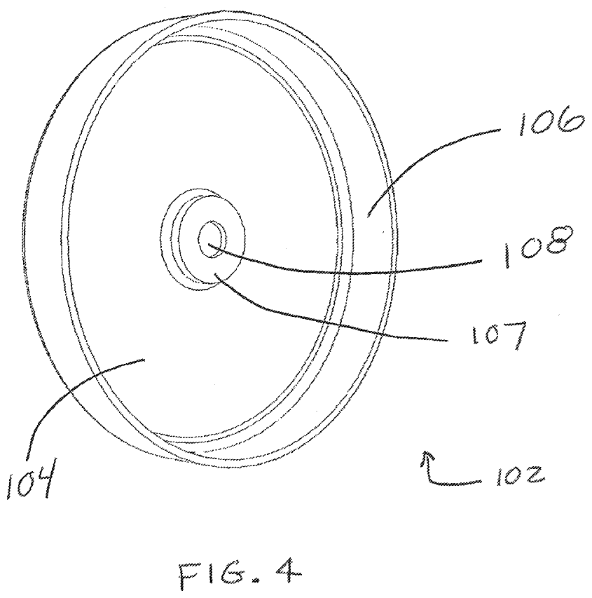

2. Referring to FIGS. 3 and 4, base 102 comprises a top wall 104, a sidewall 106, and a centrally disposed recessed cavity 107, and an opening 108 disposed in cavity 107. As will be shown more fully herein, lower end portion 112 of pole 110 is fastened within cavity 107 of base 102, which may involve adhesive bonding, screwing, welding, or any other suitable fastening method. In the embodiment shown, base 102 is of circular shape with a low profile. Base 102 may of any other shape of aesthetic design. Base 102 maybe made from plastic and fabricated by convention injection molding processes. Base 102 may be made from many other materials and corresponding conventional fabrication processes.

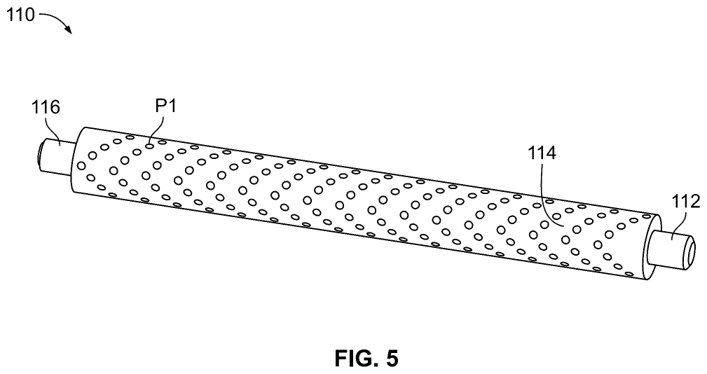

3. Referring to FIG. 5, pole 110 comprises a lower end portion 112, a body portion 114, and an upper end portion 116. Lower end portion 112 of pole 110 is securely fastened within cavity 107 of base 102, which may involve adhesive bonding, screwing, welding, or any other suitable fastening method. In the embodiment shown, pole base 110 is cylindrically shaped, hollow, and has a straight profile, allowing for enhanced internal air circulation. Pole 110 is further enhanced by incorporating a series of perforations along its body portion 114, designated as P1. These perforations, P1, are designed to optimize airflow around and through the pole, facilitating the upward movement of ethylene gas, a natural byproduct of banana ripening. The perforations P1 may vary in pattern, size, and arrangement to accommodate different environmental conditions and specific ripening needs, thereby enhancing the customization of the ripening process. This modification aids in the uniform ripening of bananas by preventing the accumulation of ethylene gas and promoting efficient gas exchange. Pole 110 may be made from wood, plastic, or other suitable materials and fabricated by conventional processes.

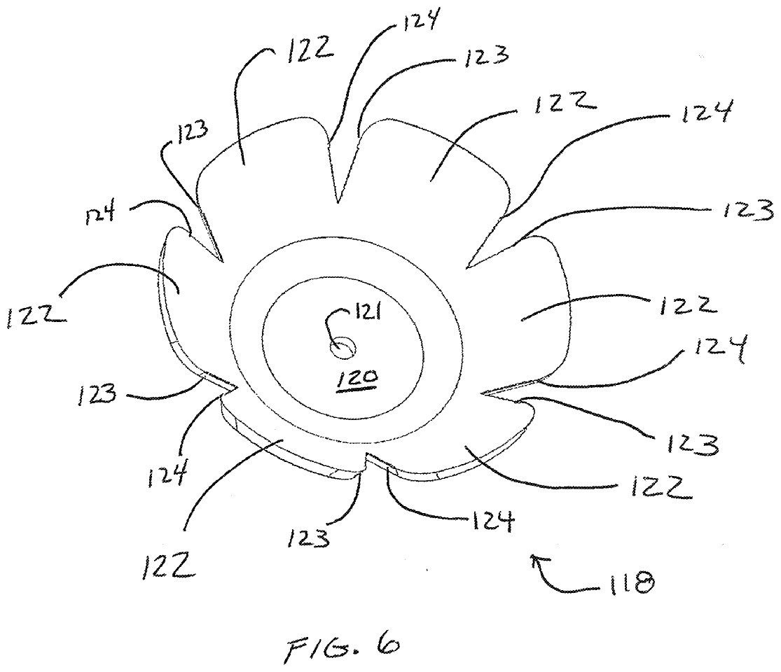

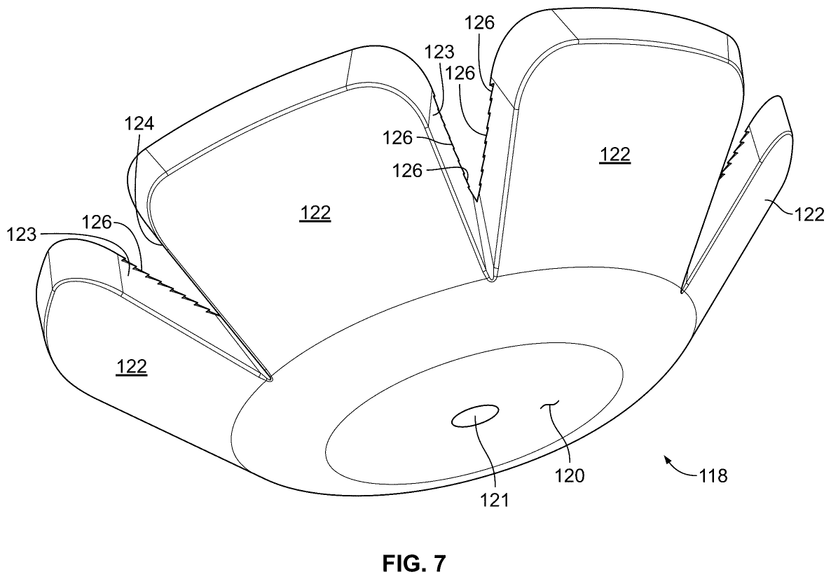

4. Referring to FIGS. 6 and 7, upper support 118 comprises a base 120 and a plurality of fingers 122 extending outward and upward from base 120. Base 120 comprises a centrally disposed opening 121 size to allow passage of upper end portion 116 of pole 110. Each of fingers 122 comprise side edges 123 and 124. As best shown in FIG. 7, each of side edges 123 and 124 comprise a plurality of notches 126 to further assist in securing the stem of an individual banana. Side edge 123 of one finger 122 and side edge 124 of an adjacent finger 122 forms a v-shaped securement zone for attaching and/or securing the stem of an individual banana. In the embodiment shown, upper support 118 is of generally circular shape. Upper support 118 may of any other shape of aesthetic design. Upper support 118 may be made from plastic and fabricated by convention injection molding processes. Upper support 118 may be made from other materials and corresponding conventional fabrication processes.

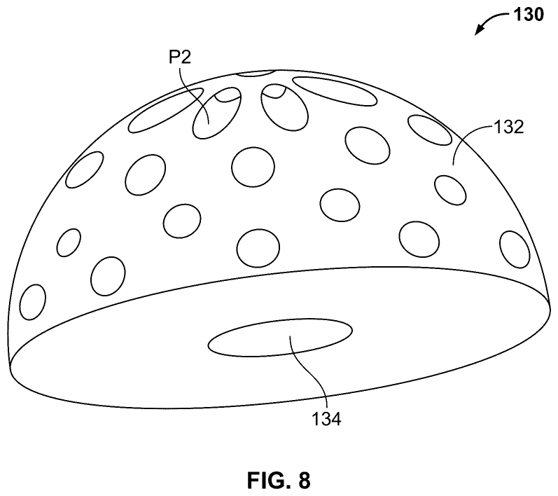

5. Referring to FIG. 8, hollow and perforated fastener 130 comprises a body portion 132 and a cavity portion 134. Upper end portion 116 of pole 110 extends thru opening 121 of upper support 118 and is secured within cavity 134 by conventional means such as adhesive bonding, screwing, welding, or any other suitable fastening method. In the embodiment shown, female hollow and perforated fastener 130 is of generally circular shape. Fastener 130 may of any other shape of aesthetic design. Hollow and perforated fastener 130 may be made from plastic and fabricated by convention injection molding processes. Fastener 130 may be made from other materials and corresponding conventional fabrication processes. As shown in FIG. 8, additional perforations, labeled P2, are designed to allow warmer air and ethylene gas to escape more efficiently, enhancing the air exchange process and contributing to the effectiveness of the holder's design in managing ethylene levels around the stored bananas.

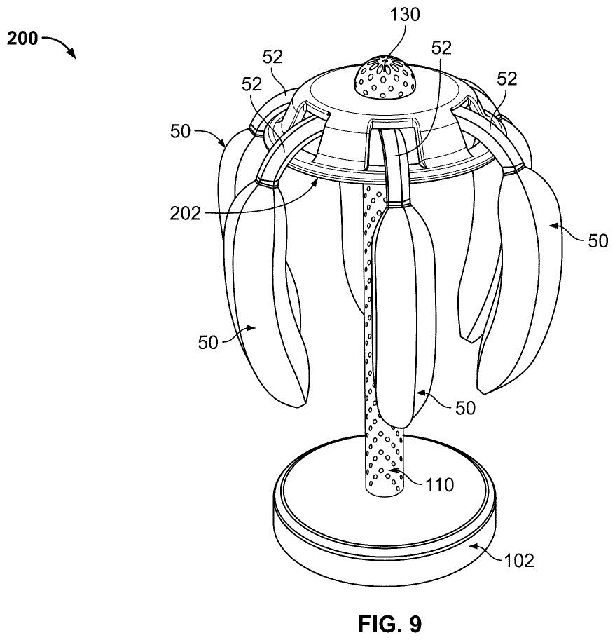

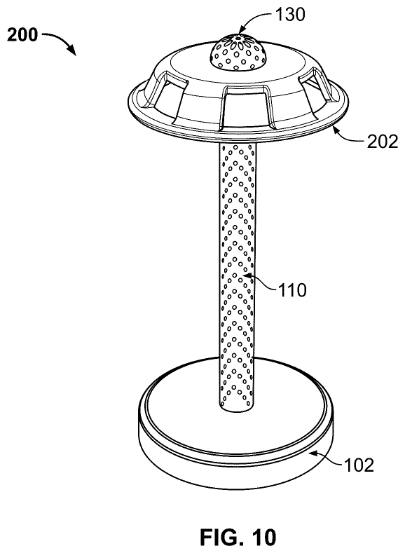

6. Referring to FIGS. 9 and 10, in a second embodiment, the present invention is a holder 200 for hanging individual bananas 50. Holder 200 generally comprises base 102, pole 110, fastener 130 as previously described in connection with the embodiment of FIGS. 1-8. Holder 200 further comprises an upper support 202 that replaces upper support 118.

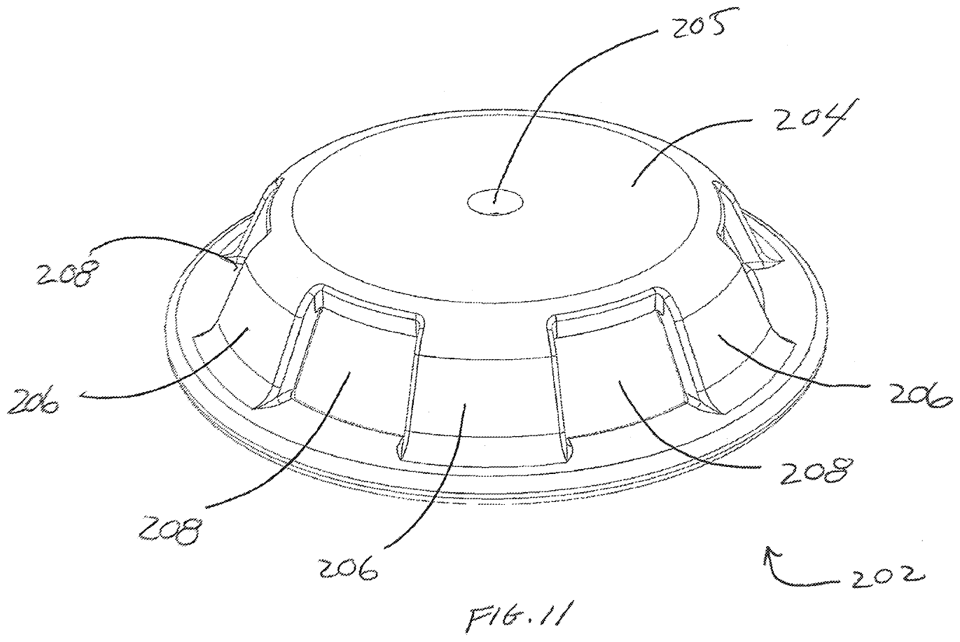

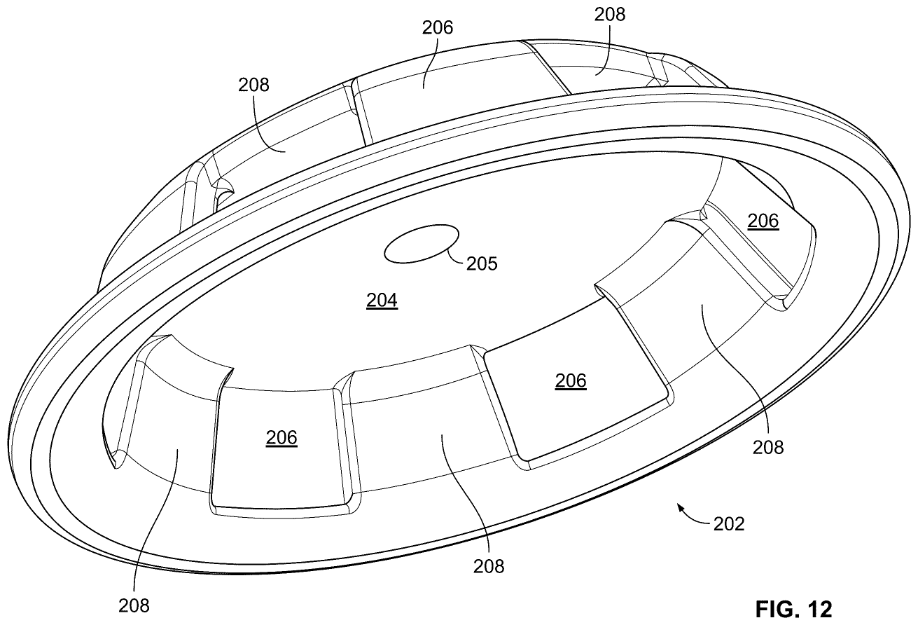

7. Referring to FIGS. 11 and 12, upper support 202 comprises a base 204 having a central opening to allow passage of upper end portion 116 of pole 110. Upper support 202 further comprises an annular sidewall 206 extending downward and outward from base 204. Upper support 202 further comprises a plurality of openings 208 formed about the perimeter of annular sidewall 206. Each of openings 208 forms a securement zone for attaching and/or securing the stem of an individual banana. In the embodiment shown, upper support 202 is of a generally circular shape. In the embodiment shown, each of openings 208 are rectangular shaped. Openings 208 may of any shape so as to secure the stem of the individual banana therein. Upper support 202 may of any other shape of aesthetic design. Upper support 202 may be made from plastic and fabricated by convention injection molding processes. Upper support 202 may be made from other materials and corresponding conventional fabrication processes.

8. While particular embodiments of the invention have been shown and described, it will be obvious to those skilled in the art that changes and modifications may be made without departing from the scope of the claimed invention.

1: A banana holder comprising: a base; a vertically extending hollow pole from said base, the pole integrated with a series of staggered perforations optimized for air and ethylene gas circulation;
an upper support connected to the top of said pole, the upper support comprising a plurality of securement zones each adapted to allow the stem of an individual banana to hang downward therefrom and incorporating a cap with larger perforations than those on the pole to prevent bottlenecking of ethylene gas and warm air; wherein the hollow nature of the pole and the configuration of the perforations on both the pole and the cap of the upper support facilitates a vacuum effect that draws cooler air from below as the warmer ethylene-rich air exits from the top, further enhanced by the upper support design that minimizes contact among bananas to aid in disease prevention thereby contributing to the overall health and longevity of the stored fruit.

2: The holder of claim 1, wherein said upper support comprises a base and first and second fingers extending upward from said base; each of said first and second fingers comprises a side edge to form said securement zone between said first and second fingers. Furthermore, the pole includes perforations labeled Pl arranged in a staggered pattern to maximize coverage area without compromising the structural integrity of the pole, thereby enhancing air circulation around the bananas and facilitating the upward movement of ethylene gas, which helps in the even ripening of the bananas.

3: The holder of claim 2, wherein each of said side edges of said first and second fingers comprises a plurality of notches to assist in securement of the stem of the individual banana.

4: The holder of claim 3, wherein said base comprises a centrally disposed recessed opening; said lower end of said pole is secured within said recessed opening of said base via adhesive bonding, screwing, welding, or any other suitable fastening method.

5: The holder of claim 4 further comprising a female fastener for engaging said upper support with said upper end of said pole, wherein said female fastener includes perforations labeled P2 as shown and described in FIG. 8, designed to allow the escape of warmer air and ethylene gas, thereby enhancing the air exchange process within the holder.

6: The holder of claim 5, wherein said upper support comprises a centrally disposed opening; said upper end of said pole passes thru said opening and is engaged with said female fastener.

7: The holder of claim 6, wherein said female fastener comprises a body and a recess; said upper end of said pole is secured within said recess of said female fastener via adhesive bonding, screwing, welding, or any other suitable fastening method.

8: The holder of claim 7, wherein said base is of any geometric shape conducive to stability and made from any suitable material including, but not limited to, plastics, metals, or composites that provide durability and support.

9: The holder of claim 7, wherein said pole has a substantially straight profile with a cross-section that may be cylindrical, elliptical, square, or any other shape that supports structural integrity and facilitates air circulation.

10: The holder of claim 9, wherein said pole is made from materials including, but not limited to, plastics, metals, wood, or any composites that meet structural and environmental requirements.

11: The holder of claim 10, wherein said upper support is constructed from any suitable material that ensures rigidity and durability, including but not limited to plastics, metals, or engineered composites.

12: The holder of claim 11, wherein said upper support comprises a base and a sidewall extending downward from the said base; said side wall comprises an opening to form said securement zone; said stem of the banana can be inserted into said securement zone.

13: The holder of claim 12, wherein said opening may be of any geometric shape, such as rectangular, circular, or oval, that facilitates secure attachment and accommodation of the banana stem.

14: The banana holder as claimed in any of the preceding claims wherein the separation between individual bananas facilitated by the upper support's design in combination with the airflow through the perforations minimizes direct contact among bananas thereby reducing the likelihood of pathogen and disease transmission among the stored fruit and contributing to the overall health and longevity of the bananas.

15: The banana holder as claimed in any of the preceding claims wherein the design is adaptable to include additional hangers or to be scaled up in dimensions allowing for the storage of multiple bananas simultaneously and accommodating varying numbers of bananas from individual to commercial scale. This flexibility ensures the holder can be tailored to meet specific requirements enhancing its utility across different settings and making it suitable for any required capacity.

16: The banana holder as claimed in any of the preceding claims wherein the holder is configurable in various external designs, shapes, and patterns which do not alter its fundamental functionality of securing bananas individually and managing ethylene gas and airflow. These variations are intended to cater to different aesthetic preferences and environmental settings thus allowing customization to user tastes and market demands.

17: The banana holder as claimed in any of the preceding claims wherein the pole can be of various shapes including but not limited to cylindrical, square, or elliptical and may include multiple poles to support a greater number of bananas thereby accommodating needs from small households to large commercial settings.

18: The banana holder as claimed in any of the preceding claims wherein the perforations on the pole are variable in size and pattern designed to optimize airflow and ethylene gas management specific to the environmental conditions and spacing requirements.

19: The banana holder as claimed in any of the preceding claims wherein the pole is configured to accommodate replaceable ethylene absorbers or filters within its hollow structure enabling enhanced control over the ethylene gas levels surrounding the stored bananas.

20: The banana holder of claim 1, further comprising a mounting mechanism configured for under-cabinet installation, wherein the upper support is connected to a short pole that is attached via a hinge to a base, the base being attachable to a surface under a cabinet or other suitable location with screws or adhesive; and a female cap beneath the upper support securing the short hanging pole to the banana support, enabling the holder to be stowed away when not in use, thereby utilizing the space efficiently without requiring a traditional base or long pole, and maintaining the holder's functionality for securing bananas individually and managing ethylene gas and airflow.
